(19) United States
(12) Patent Application Publication
(10) Pub. No.: US 2026/0019454 A1
(43) Pub. Date: Jan. 15, 2026

(54) SYSTEM AND METHOD FOR REUSE OF SESSION PARAMETERS ACROSS DIFFERENT NETWORKS

(71) Applicant: JIO PLATFORMS LIMITED, Ahmedabad, Gujarat (IN)

(72) Inventors: Hardik Navinbhai BAVISHI, Navi Mumbai, Maharashtra (IN); Arpan NANDA, Navi Mumbai, Maharashtra (IN); Pradeep Kumar BHATNAGAR, Navi Mumbai, Maharashtra (IN); Aayush BHATNAGAR, Navi Mumbai, Maharashtra (IN)

(73) Assignee: JIO PLATFORMS LIMITED, Ahmedabad, Gujarat (IN)

(21) Appl. No.: 18/881,355

(22) PCT Filed: Dec. 23, 2023
(86) PCT No.: PCT/IB2023/063213

§ 371 Date: Jan. 6, 2025

(30) Foreign Application Priority Data
Dec. 28, 2022 (IN) 202221076367

(51) Int. Cl. H04L 65/1095; H04L 65/102; H04W 12/06

(52) U.S. Cl. CPC H04L 65/1095; H04L 65/102; H04W 12/06

(57) ABSTRACT

The present disclosure provides a system and a method for selecting a session management function/packet gateway (SMF/PGW-C) and existing session parameters from a third-generation partnership project (3GPP) access network session. Further, the system utilizes existing session parameters for a wireless fidelity (Wi-Fi) service independent of an access point name/data network name (APN/DNN) over 4G or 5G access networks. The SMF/PGW-C will be able to use an international mobile equipment identity (IMEI) from the 3GPP Session for enforcing user equipment (UE) model/vendor specific policies through the Wi-Fi offload services. Additionally, the SMF/PGW-C will be able to use the 3GPP UE location information for applying location-based policies over the Wi-Fi network to ensure uniform policy application across 3GPP and non-3GPP access networks.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for mobile network policy management. More particularly, the present disclosure relates to a system and a method for reuse of session parameters across different network types independent of an access point name/data network name (APN/DNN).

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

In the existing standards and specifications, a third generation partnership project (3GPP) access network and a non-3GPP access network with wireless fidelity (Wi-Fi) provide different set of session parameters to a core network. If an operator wants to apply a policy based on a session parameter which might be available in a specific access network only but not in other, policy enforcement might not be uniform across access network types. Further, most user equipments do not provide the same session parameters during a user session request over the non-3GPP network using Wi-Fi.

There is, therefore, a need in the art to provide a system and a method that can mitigate the problems associated with the prior arts.

### OBJECTS OF THE INVENTION

Some of the objects of the present disclosure, which at least one embodiment herein satisfies are listed herein below.

It is an object of the present disclosure to provide a system and a method that uses the same session management function/packet gateway (SMF/PGW-C) selected over a third generation partnership project (3GPP) network.

It is an object of the present disclosure to provide a system and a method where the SMF/PGW-C checks the presence of existing 3GPP access network session and utilizes the existing session parameters for wireless fidelity (Wi-Fi) service independent of an access point name/data network name (APN/DNN) over fourth generation (4G) or fifth generation (5G) access networks.

It is an object of the present disclosure to provide a system and a method where the SMF/PGW-C uses a session parameter such as an international mobile equipment identity (IMEI) from the 3GPP session for enforcing user equipment (UE) model/vendor specific policies for one or more Wi-Fi offload services available to the UE models.

It is an object of the present disclosure to provide a system and a method where the SMF/PGW-C uses the UE location information for applying location-based policies over the Wi-Fi network that ensures uniform policy application across 3GPP and non-3GPP access networks.

It is an object of the present disclosure to provide a system and a method where the UE session parameters are captured in a user call data record (CDR) and forwarded to a lawful interception management system (LIMS).

It is an object of the present disclosure to provide a system and a method that reduces the need of a transaction processing system (TPS) requirement on 3GPP AAA as Sh query is not required.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for reusing session parameters. The system includes a processor, and a memory operatively coupled to the processor, where the memory stores instructions to be executed by the processor. The processor receives a user session request from one or more computing devices for connecting to a non-third generation partnership project (non-3GPP) network. The one or more computing devices are communicatively coupled to the processor via a 3GPP network. The processor determines if a user session for the one or more computing devices exists with the 3GPP network. In response to a positive determination, the processor establishes communication between the one or more computing devices and a session management function (SMF)/packet gateway (PGW-C). The processor extracts one or more session parameters associated with the user session of the 3GPP network via the SMF/PGW-C. The processor enables one or more policies associated with the one or more computing devices via the SMF/PGW-C based on the one or more session parameters.

In an embodiment, in response to a negative determination, the processor may decline the user session request for connecting to the non-3GPP network.

In an embodiment, the processor may extract the one or more session parameters via the SMF/PGW-C independent of an access point name (APN) and a data network name (DNN).

In an embodiment, the one or more session parameters may include at least one of an international mobile equipment identity (IMEI) and a user equipment (UE) 3GPP location from the 3GPP network.

In an aspect, the present disclosure relates to a method for reusing session parameters. The method includes receiving, by a processor associated with a system, a user session request from one or more computing devices for connecting to a non-3GPP network. The one or more computing devices are communicatively coupled to the processor via a 3GPP network. The method includes determining, by the processor, if a user session for the one or more computing devices exists with the 3GPP network. The method includes establishing, by the processor, communication between the one or more computing devices and a SMF/PGW-C, in response to a positive determination. The method includes extracting, by the processor, one or more session parameters associated with the user session of the 3GPP network via the SMF/PGW-C. The method includes enabling, by the processor, one or more policies via the SMF/PGW-C based on the one or more session parameters.

In an embodiment, the method may include declining, by the processor, in response to a negative determination, the user session request for connecting to the non-3GPP network.

In an embodiment, the method may include extracting, by the processor, the one or more session parameters via the SMF/PGW-C independent of the APN and a DNN.

In an embodiment, the one or more session parameters may include at least one of an IMEI and a UE 3GPP location from the 3GPP network.

In an aspect, a user equipment (UE) for sending requests may include one or more processors communicatively coupled to a processor associated with a system. The one or more processors are coupled with a memory. Said memory stores instructions which, when executed by the one or more processors, cause the one or more processors to transmit a user session request to the processor for connecting to a non-3GPP network. The processor is configured to receive the request from the UE. The processor is configured to determine if a user session for the one or more computing devices exists with the 3GPP network. The processor is configured to establish communication between the UE and a SMF/PGW-C, in response to a positive determination. The processor is configured to extract one or more session parameters associated with the user session of the 3GPP network via the SMF/PGW-C. The processor is configured to enable one or more policies associated with the UE via the SMF/PGW-C based on the one or more session parameters.

In an aspect, a non-transitory computer readable medium includes a processor with executable instructions, causing the processor to receive a user session request from one or more computing devices for connecting to a non-3GPP network. The one or more computing devices are communicatively coupled to the processor via a 3GPP network. The processor determines if a user session for the one or more computing devices exists with the 3GPP network. The processor establishes communication between the one or more computing devices and a SMF/PGW-C in response to a positive determination. The processor extracts one or more session parameters associated with the user session of the 3GPP network via the SMF/PGW-C. The processor enables one or more policies associated with the one or more computing devices via the SMF/PGW-C.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example network architecture (100) for implementing a proposed system, in accordance with an embodiment of the present disclosure.

FIG. 2 illustrates an example block diagram (200) of a proposed system (116), in accordance with an embodiment of the present disclosure.

FIG. 3 illustrates an example flow diagram of a method (300) implemented by the proposed system (116), in accordance with an embodiment of the present disclosure.

FIG. 4 illustrates an example computer system (400) in which or with which a proposed system (116) may be implemented, in accordance with an embodiment of the present disclosure.

The foregoing shall be more apparent from the following more detailed description of the disclosure.

### BRIEF DESCRIPTION OF THE INVENTION

In the following description, for explanation, various specific details are outlined in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items.

In accordance with the present disclosure, some of the session parameters are optional in a non-third generation partnership project (non-3GPP) session. Hence, most of the user equipment (UE) configurations do not provide the session parameters during a user session create request over the non-3GPP network, for example over a wireless fidelity (Wi-Fi). In some cases, the user session may be created through a third generation partnership project (3GPP) access network for any access point name/data network name (APN/DNN). The present disclosure provides a mechanism for selecting the same session management function packet gateway (SMF/PGW-C), selected over the 3GPP network independent of the APN/DNN. Further, extra session parameters which are ideally not available from non-3GPP access network may be obtained from existing 3GPP access network sessions. Further, the present disclosure may be applicable to the Wi-Fi services associated with universal integrated circuit card (UICC) based subscribers in a telecommunication network.

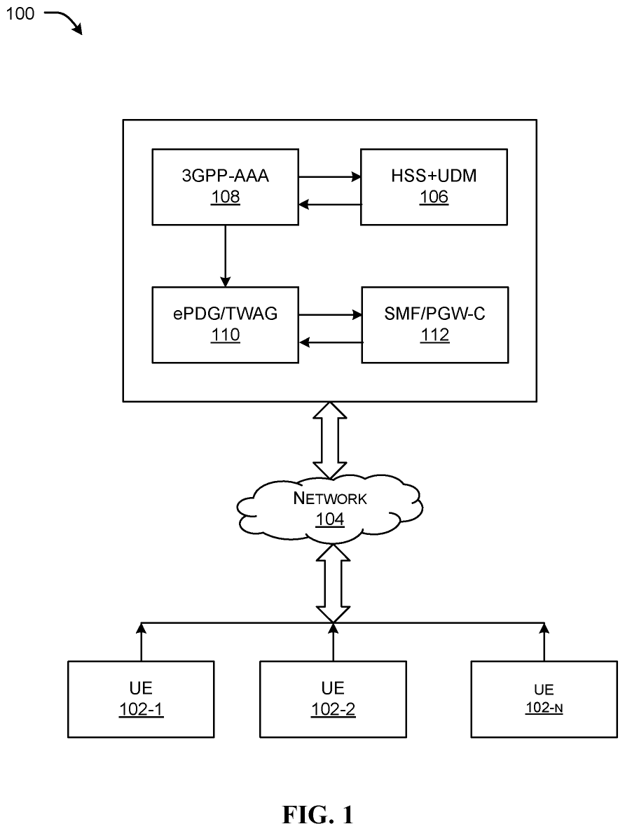

The various embodiments throughout the disclosure will be explained in more detail with reference to FIGS. 1-4.

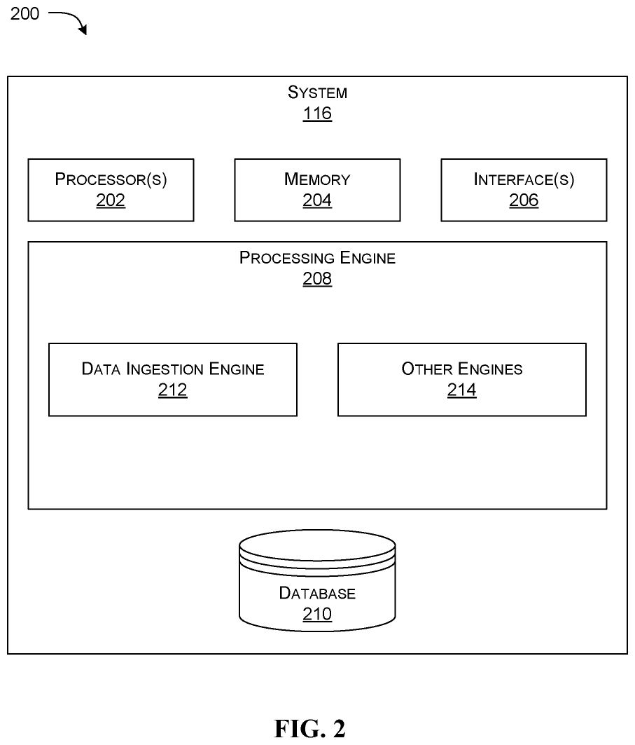

FIG. 1 illustrates an exemplary network architecture (100) for implementing a proposed system, in accordance with an embodiment of the present disclosure. As illustrated in FIG. 1, one or more user equipments (102-1, 102-2 . . . 102-N) may be connected to the proposed system through a network (104). A person of ordinary skill in the art will understand that the one or more user equipments (102-1, 102-2 . . . 102-N) may be collectively referred as the user equipments or computing devices (102) and individually referred as the user equipment or computing device (102). In an embodiment, the network (104) may be interchangeably referred as a 3GPP network (104) throughout the disclosure. Further, a system (116 of FIG. 2) may be interchangeably referred as a 3GPP-authentication, authorization, and accounting server (AAA) (108) throughout the disclosure.

In an embodiment, the user equipment (102) may include, but not be limited to, a mobile, a laptop, etc. Further, the user equipment (102) may include one or more in-built or externally coupled accessories including, but not limited to, a visual aid device such as a camera, audio aid, microphone, or keyboard. Further, the user equipment (102) may include a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from a user such as a touchpad, touch-enabled screen, electronic pen, and the like may be used.

In an embodiment, the network/3GPP network (104) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (104) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

As illustrated in FIG. 1, a home subscriber service and unified data management (HSS+UDM) (106) may return the last connected SMF/PGW-C (112) information to the 3GPP AAA (108) during an authorization flow over a wireless fidelity (Wi-Fi) network/non-3GPP network. Further, the 3GPP AAA (108) may modify a user APN-profile of a requested APN to remove “packet data network gateway (PDN-GW)-allocation-type” attribute value-pair (AVP). This may indicate the AVP value as “STATIC” to an evolved packet data gateway/trusted wireless local area network (WLAN) access gateway (ePDG/TWAG) (110). This may ensure that the user (102) connects to the same SMF/PGW-C (112) as in the 3GPP network (104). Further, the SMF/PGW-C (112) may use the existing session parameters for a wireless fidelity (Wi-Fi) attach procedure, apply configured policies, and proceed to the subsequent steps of the attach procedure. Additionally, the SMF/PGW-C (112) may obtain extra session parameters such as an international mobile equipment identity (IMEI) and a user equipment (UE) 3GPP location from existing 3GPP access network sessions.

In an embodiment, the proposed system (116) may utilize existing session parameters over a 3GPP network session for Wi-Fi service independent of the APN/DNN over fourth generation (4G) or fifth generation (5G) access networks.

In an embodiment, the SMF/PGW-C (112) may be able to use the IMEI from the 3GPP session for enforcing UE model/vendor specific policies with Wi-Fi offload services available to UE models.

In an embodiment, the SMF/PGW-C (112) may be able to use the 3GPP UE location information for applying location-based policies over the Wi-Fi network to ensure a uniform policy application across 3GPP and non-3GPP access networks.

In an embodiment, the 3GPP UE location information may be captured in a user call data record (CDR) and forwarded to a lawful interception management system (LIMS).

In an embodiment, the system (116) may receive a user session request from the one or more computing devices (102) for connecting to a non-3GPP network. The system (106) may determine if a user session for the one or more computing devices (102) exists with the 3GPP network (104). In response to a positive determination, the system (116) may transmit a modified user APN profile to a gateway (110) to enable connection to a SMF/PGW-C (112) configured with the 3GPP network (104). The system (116) may receive information about the SMF/PGW-C (112) configured with the 3GPP network (104) via the HSS+UDM (106).

In response to a negative determination, the system (116) may decline the user session request for connecting to the non-3GPP network.

In an embodiment, the system (116) may establish communication between the one or more computing devices (102) and the SMF/PGW-C (112). The gateway (110) may be an ePDG/TWAG.

In an embodiment, the system (116) may extract one or more session parameters associated with the user session of the 3GPP network (104) via the SMF/PGW-C (112). The system (116) may extract the one or more session parameters via the SMF/PGW-C (112) independent of the APN and a DNN. The one or more session parameters may include but not limited to an IMEI and a UE 3GPP location from the 3GPP network (104).

Further, the system (106) may enable one or more policies via the SMF/PGW-C (112) based on the one or more session parameters. The one or more policies may include Wi-Fi offload services available to UE models of a specific make. Further, the one or more policies may include location based policies over the Wi-Fi network. The system (116) may ensure uniform policy application across the 3GPP network (104) and the non-3GPP network.

In an embodiment, the SMF/PGW-C (112) may check the presence of an existing 3GPP network session and utilize the existing session parameters for the Wi-Fi service independent of the APN/DNN over 4G or 5G access networks.

In an embodiment, the SMF/PGW-C (112) may use the IMEI from 3GPP session for enforcing UE model/vendor specific policies like making Wi-Fi offload services available to UE models of a specific make.

In an embodiment, the SMF/PGW-C (112) may use the 3GPP UE location information for applying location-based policies over the non-3GPP network/Wi-Fi network. This may ensure uniform policy application across the 3GPP network (104) and the non-3GPP network. Further, a location may also be captured in a user CDR by the SMF/PGW-C (112) and forwarded to a LIMS module.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

FIG. 2 illustrates an example block diagram (200) of a proposed system (116), in accordance with an embodiment of the present disclosure.

Referring to FIG. 2, the system (116) may comprise one or more processor(s) (202) that may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (116). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (116) may include an interface(s) (206). The interface(s) (206) may comprise a variety of interfaces, for example, interfaces for data input and output (I/O) devices, storage devices, and the like. The interface(s) (206) may also provide a communication pathway for one or more components of the system (116). Examples of such components include, but are not limited to, processing engine(s) (208) and a database (210), where the processing engine(s) (208) may include, but not be limited to, a data ingestion engine (212) and other engine(s) (214). In an embodiment, the other engine(s) (214) may include, but not limited to, a data management engine, an input/output engine, and a notification engine.

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (116) may comprise the machine-readable storage medium storing the instructions and the processing resource to execute the instructions, or the machine-readable storage medium may be separate but accessible to the system (116) and the processing resource. In other examples, the processing engine(s) (208) may be implemented by electronic circuitry.

In an embodiment, the processor (202) may receive a user session request input via the data ingestion engine (212). The user session request may be received from one or more computing devices (102) for connecting to a non-3GPP network. The processor (202) may determine if a user session for the one or more computing devices (102) exists with the 3GPP network (104). In response to a positive determination, the processor (202) may transmit a modified user APN profile to a gateway (110) to enable connection to same SMF/PGW-C (112) configured with the 3GPP network (104). The processor (202) may receive the SMF/PGW-C (112) configured with the 3GPP network (104) via the HSS+UDM (106).

In an embodiment, the processor (202) may establish communication between the one or more computing devices (102) and the SMF/PGW-C (112).

In an embodiment, the processor (202) may extract one or more session parameters associated with the user session of the 3GPP network (104) via the SMF/PGW-C (112). The processor (202) may extract the one or more session parameters via the SMF/PGW-C (112) independent of the APN and a DNN. The one or more session parameters may include but not limited to an IMEI and a UE 3GPP location from the 3GPP network (104).

Further, the processor (202) may enable one or more policies via the SMF/PGW-C (112) based on the one or more session parameters. The one or more policies may include Wi-Fi offload services available to UE models of a specific make. Further, the one or more policies may include location based policies over the Wi-Fi network. The processor (202) may ensure uniform policy application across the 3GPP network (104) and the non-3GPP network.

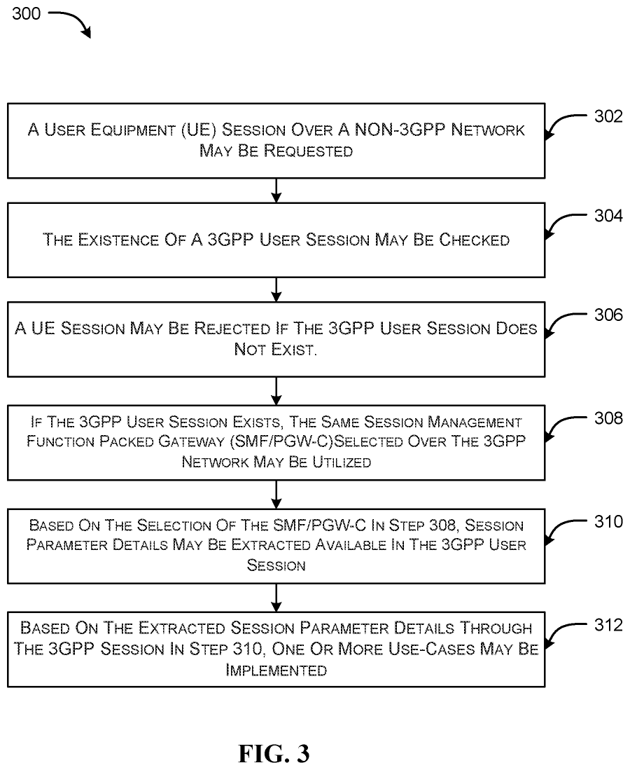

FIG. 3 illustrates a flow diagram of a method (300) implemented by the proposed system (116), in accordance with an embodiment of the present disclosure.

At Step 302: A user equipment (UE) session over a non-3GPP network may be requested.

At Step 304: The existence of a 3GPP user session may be checked.

At Step 306: A UE session may be rejected if the 3GPP user session does not exist.

At Step 308: If the 3GPP user session exists, the same session management function packed gateway (SMF/PGW-C) (112) selected over the 3GPP network (104) may be utilized.

At Step 310: Based on the selection of the SMF/PGW-C (112) in step 308, session parameter details may be extracted available in the 3GPP user session.

At Step 312: Based on the extracted session parameter details through the 3GPP session in step 310, one or more use-cases may be implemented.

Therefore, in accordance with embodiments of the present disclosure, the system (116) uses the same SMF/PGW-C selected over a 3GPP network. The SMF/PGW-C checks the presence of existing 3GPP access network session and utilizes the existing session parameters for a wireless fidelity (Wi-Fi) service independent of an APN/DNN over 4G or 5G access networks. The SMF/PGW-C uses a session parameter such as an international mobile equipment identity (IMEI) from the 3GPP session for enforcing user equipment (UE) model/vendor specific policies for one or more Wi-Fi offload services available to UE models. Further, the SMF/PGW-C uses the 3GPP UE location information for applying location-based policies over the Wi-Fi network that ensures uniform policy application across 3GPP and non-3GPP access networks. Hence, the system (116) reduces the need for Sh query on 3GPP authentication, authorization, and accounting for obtaining the user state and the 3GPP user location. Further, the system reduces the need of a transaction processing system (TPS) requirement on 3GPP AAA server as Sh query is not required, thereby improvises the capabilities of communication system and optimized usage of the resources in communication.

It will be appreciated that the steps shown in FIG. 3 are merely illustrative. Other suitable steps may be used, if desired. Moreover, the steps of the method 300 may be performed in any order and may include additional steps.

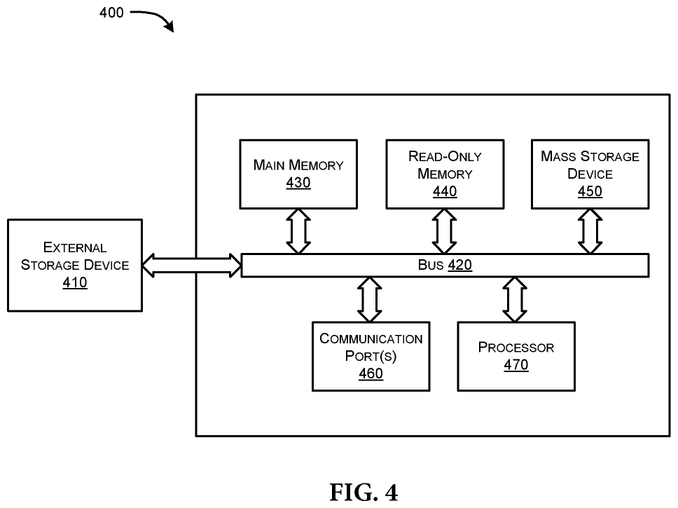

FIG. 4 illustrates an exemplary computer system (400) in which or with which the proposed system (116) may be implemented, in accordance with an embodiment of the present disclosure.

As shown in FIG. 4, the computer system (400) may include an external storage device (410), a bus (420), a main memory (430), a read-only memory (440), a mass storage device (450), a communication port(s) (460), and a processor (470). A person skilled in the art will appreciate that the computer system (400) may include more than one processor and communication ports. The processor (470) may include various modules associated with embodiments of the present disclosure. The communication port(s) (460) may be any of an RS-232 port for use with a modem-based dialup connection, a 10/100 Ethernet port, a Gigabit or 10 Gigabit port using copper or fibre, a serial port, a parallel port, or other existing or future ports. The communication port(s) (460) may be chosen depending on a network, such as a Local Area Network (LAN), Wide Area Network (WAN), or any network to which the computer system (400) connects. The main memory (430) may be Random Access Memory (RAM), or any other dynamic storage device commonly known in the art. The read-only memory (440) may be any static storage device(s) e.g., but not limited to, a Programmable Read Only Memory (PROM) chip for storing static information e.g., start-up or basic input/output system (BIOS) instructions for the processor (470). The mass storage device (450) may be any current or future mass storage solution, which can be used to store information and/or instructions.

The bus (420) may communicatively couple the processor (470) with the other memory, storage, and communication blocks. Optionally, operator and administrative interfaces, e.g., a display, keyboard, and cursor control device may also be coupled to the bus (420) to support direct operator interaction with the computer system (400). Other operator and administrative interfaces can be provided through network connections connected through the communication port(s) (460). In no way should the aforementioned exemplary computer system (400) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method that uses the same session management function packed gateway (SMF/PGW-C) selected over a third generation partnership project (3GPP) network.

The present disclosure provides a system and a method where the SMF/PGW-C checks the presence of existing 3GPP access network session and utilizes the existing session parameters for a wireless fidelity (Wi-Fi) service independent of an access point name/data network name (APN/DNN) over fourth generation (4G) or fifth generation (5G) access networks.

The present disclosure provides a system and a method where the SMF/PGW-C uses a session parameter such as an international mobile equipment identity (IMEI) from the 3GPP session for enforcing user equipment (UE) model/vendor specific policies for one or more Wi-Fi offload services available to UE models.

The present disclosure provides a system and a method where the SMF/PGW-C uses the 3GPP UE location information for applying location-based policies over the Wi-Fi network that ensures uniform policy application across 3GPP and non-3GPP access networks.

The present disclosure provides a system and a method where the UE session parameters are captured in a user call data record (CDR) and forwarded to a lawful interception management system (LIMS).

The present disclosure provides a system and a method that reduces the need of a transaction processing system (TPS) requirement on 3GPP authentication, authorization, and accounting (AAA) server as Sh query is not required.

The present disclosure provides a system and method that improvises the capabilities of communication system and optimized usage of the resources in communication.

We claim:

1. A system (116) for reusing session parameters, the system (116) comprising:
a processor (202) configured with an authentication, authorization, and accounting (AAA) server (108); and
a memory (204) operatively coupled with the processor (202), wherein said memory (204) stores instructions which, when executed by the processor (202), cause the processor (202) to:
receive a user session request from one or more computing devices (102) for connecting to a non-third generation partnership project (non-3GPP) network, wherein the one or more computing devices (102) are communicatively coupled to the processor (202) via a 3GPP network (104);
determine if a user session for the one or more computing devices (102) exists with the 3GPP network (104);
in response to a positive determination, establish communication between the one or more computing devices (104) and a session management function (SMF)/packet gateway (PGW-C) (112);
extract one or more session parameters associated with the user session of the 3GPP network (104) via the SMF/PGW-C (112); and
enable one or more policies via the SMF/PGW-C (112) based on the one or more session parameters.

2. The system (116) as claimed in claim 1, wherein in response to a negative determination, the processor (202) is to decline the user session request for connecting to the non-3GPP network.

3. The system (116) as claimed in claim 1, wherein the processor (202) is to extract the one or more session parameters via the SMF/PGW-C (112) independent of an access point name (APN) profile and a data network name (DNN).

4. The system (116) as claimed in claim 1, wherein the one or more session parameters comprise at least one of: an international mobile equipment identity (IMEI) and a user equipment (UE) 3GPP location from the 3GPP network (104).

5. A method for reusing session parameters, the method comprising:
receiving, by a processor (202) associated with a system (116), a user session request from one or more computing devices (102) for connecting to a non-third generation partnership project (non-3GPP) network, wherein the one or more computing devices (102) are communicatively coupled to the processor (202) via a 3GPP network (104);
determining, by the processor (202), if a user session for the one or more computing devices (102) exists with the 3GPP network (104);
in response to a positive determination, establishing, by the processor (202), communication between the one or more computing devices (102) and a session management function (SMF)/packet gateway (PGW-C) (112);
extracting, by the processor (202), one or more session parameters associated with the user session of the 3GPP network (104) via the SMF/PGW-C (112); and
enabling, by the processor (202), one or more policies via the SMF/PGW-C (112) based on the one or more session parameters.

6. The method as claimed in claim 5, comprising declining, by the processor (202), in response to a negative determination, the user session request for connecting to the non-3GPP network.

7. The method as claimed in claim 5, comprising extracting, by the processor (202), the one or more session parameters via the SMF/PGW-C (112) independent of an access point name (APN) profile and a data network name (DNN).

8. The method as claimed in claim 5, wherein the one or more session parameters comprise at least one of: an international mobile equipment identity (IMEI) and a user equipment (UE) 3GPP location from the 3GPP network (104).

9. A user equipment (UE) (102) for sending requests, the UE (102) comprising:
one or more processors communicatively coupled to a processor (202) associated with a system (116), wherein the one or more processors are coupled with a memory, and wherein said memory stores instructions which, when executed by the one or more processors, cause the one or more processors to:
transmit a user session request to the processor (202) for connecting to a non-third generation partnership project (non-3GPP) network,
wherein the processor (202) is configured to:
receive the user session request from the UE (102);
determine if a user session for the one or more computing devices (102) exists with a 3GPP network (104);
in response to a positive determination, establish communication between the UE (102) and a session management function (SMF)/packet gateway (PGW-C) (112);
extract one or more session parameters associated with the user session of the 3GPP network (104) via the SMF/PGW-C (112); and
enable one or more policies associated with the UE (102) via the SMF/PGW-C (112) based on the one or more session parameters.

10. A non-transitory computer readable medium comprising a processor with executable instructions, causing the processor to:
receive a user session request from one or more computing devices (102) for connecting to a non-third generation partnership project (non-3GPP) network;
determine if a user session for the one or more computing devices (102) exists with a 3GPP network (104);
in response to a positive determination, establish communication between the one or more computing devices (102) and a session management function (SMF)/packet gateway (PGW-C) (112);
extract one or more session parameters associated with the user session of the 3GPP network (104) via the SMF/PGW-C (112); and
enable one or more policies associated with the one or more computing devices (102) via the SMF/PGW-C (112).
